(19) United States
(12) Patent Application Publication
(10) Pub. No.: US 2008/0188272 A1
(43) Pub. Date: Aug. 7, 2008

(54) Information Terminal

(75) Inventor: Akihiro Ohmoto, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/569,251

(22) PCT Filed: Apr. 19, 2005
(86) PCT No.: PCT/JP05/07447

§ 371 Date: Nov. 17, 2006

(30) Foreign Application Priority Data
Jun. 22, 2004 (JP) 2004-183763

(51) Int. Cl. H04M 1/00

(52) U.S. Cl. 455/575.1

(57) ABSTRACT

An object of the present invention is to provide an information terminal by which a user can easily perform an operation for executing a function intended by the user.

An information terminal having a key operation guidance function for assisting a user to perform an operation required for execution of a function set in a mobile phone terminal 100, including a key input portion 10 having a plurality of keys capable of emitting light independently of one another, and a key operation guidance control portion 81 having a function for specifying a key the user should operate for executing the function and a function for lighting the specified key.

### TECHNICAL FIELD

The present invention relates to an information terminal having an assistance function for assisting a user to perform an operation required for execution of a function set in the information terminal.

### BACKGROUND ART

Information terminals such as mobile phones, personal handyphone systems (PHS), and the like, have been sophisticated. For example, a function for transmitting/receiving an electronic mail or a function as a digital camera has been added to the information terminals. With the advance in the functions, a large number of functions are assigned to a limited number of keys. For this reason, key operation may be too complicated to be understood particularly by beginners.

Various means for solving this problem have been heretofore proposed. For example, there has been proposed a mobile communication terminal in which a location of a key required for a key operation corresponding to an event such as an incoming call is displayed by an illustration on a display of the mobile communication terminal when the event occurs (e.g. see Patent Document 1).

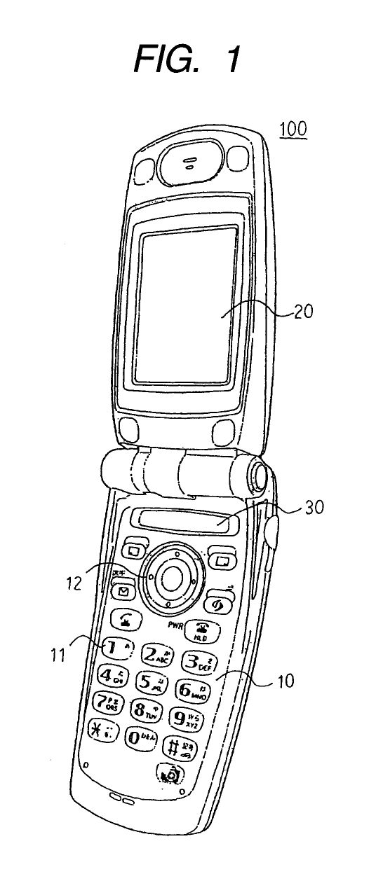

### Patent Document 1: JP-A-2004-64526 (pp. 4-7, FIG. 1)

### DISCLOSURE OF THE INVENTION

### Problem that the Invention is to Solve

There has been, however, a problem that the display of the mobile communication terminal according to the related art is so small that the location of a key to be actually operated is considerably difficult to know even if the illustration indicating the location of the key required for the key operation is viewed. Particularly when there are a plurality of options of key operations corresponding to one event (e.g. there are options such as “start to answer” or “hold” for an incoming call), accurate operation guidance cannot be performed unless locations of keys required for the key operations can be covered within one display screen in a lump. In addition, there has been another problem that a large number of pieces of display image data corresponding to events have to be stored.

What lies behind the problem can be considered as a point that the related-art mobile communication terminal makes a user not directly recognize all the locations of keys to be operated actually when an event occurs but indirectly grasp the locations of the keys from the display on the display portion.

The present invention was developed in consideration of the aforementioned circumstances. An object of the present invention is to provide an information terminal by which a user can easily perform an operation for executing a function intended by the user.

### Means for Solving the Problem

The information terminal according to the present invention is an information terminal having an assistance function for assisting a user to perform an operation required for execution of a function set in the information terminal, comprising input means including a plurality of input portions capable of emitting light independently of one another, specifying means for specifying one of the input portions to be operated by the user for the purpose of executing the function, and lighting control means for lighting the specified input portion. With the aforementioned configuration, since the lighting control means for lighting a specified input portion is provided, the user can intuitively grasp that the user should operate the lit input portion. Accordingly, the user can easily perform an operation for executing a function intended by the user.

In the information terminal according to the present invention, the assistance function is activated in response to occurrence of an event for executing the function set in the information terminal. With the aforementioned configuration, the assistance function is activated in response to occurrence of an event for executing the function set in the information terminal. It is therefore possible to assist the user to perform an operation when there has occurred an event such as an incoming call or mail or user's key input.

In the information terminal according to the present invention, the specifying means specifies a plurality of input portions corresponding to a plurality of selectively executable actions set for the function; and the lighting control means lights the input portions in different modes respectively. With the aforementioned configuration, the lighting control means lights the input portions in different modes respectively, so that identifiability in the case where there are a plurality of actions can be improved.

In the information terminal according to the invention, the lighting control means lights the input portion corresponding to, of the plurality of selectively executable actions, an action for aborting the function, so as to draw user's attention. With the aforementioned configuration, the lighting control means lights the input portion corresponding to, of the plurality of selectively executable actions, the action for aborting the function, so as to draw user's attention. It is easy for the user to intuitively grasp that the user has to perform the action carefully.

In the information terminal according to the present invention, the lighting control means emphatically lights the input portion corresponding to, of the plurality of selectively executable actions, an action for advancing the function. With the aforementioned configuration, the lighting control means emphatically lights the input portion corresponding to, of the plurality of selectively executable actions, the action for advancing the function. For example, the lighting control means blinks the input portion. It is therefore easy for the user to intuitively perform the action for advancing the function.

The information terminal according to the present invention further comprises display control means for displaying assistance information for assisting the operation at timing when the input portion is lit. With the aforementioned configuration, the assistance information for assisting the operation is displayed at timing when the input portion is lit. Accordingly, the assistance information for assisting the operation can be confirmed by display. Thus, operability can be improved.

In the information terminal according to the present invention, the specifying means specifies a plurality of input portions corresponding to a plurality of selectively executable actions set for the function; and the display control means displays a plurality of pieces of assistance information for assisting the operation in different modes. With the aforementioned configuration, the plurality of pieces of assistance information for assisting the operation are displayed in different modes, so that identifiability in the case where there are a plurality of actions can be improved.

The information terminal according to the present invention further comprises voice control means for vocalizing the assistance information for assisting the operation at timing when the input portion is lit. With the aforementioned configuration, the assistance information for assisting the operation can be vocalized at the timing when the input portion is lit, so that the assistance information for assisting the operation can be confirmed by voice. Thus, operability can be improved.

The information terminal according to the present invention further comprises control means for synchronizing a period for the lighting control means to blink the input portion with a period for the display control means to blink and display the assistance information. With the aforementioned configuration, the period for the lighting control means to blink the input portion is synchronized with the period for the display control means to blink and display assistance information, so that assistance for the user can be emphasized visually.

The information terminal according to the present invention further comprises detection means for detecting an operation on an input portion specified by the specifying means, and vibrating means which vibrates in accordance with a result of the detection. With the aforementioned configuration, the vibrating means vibrating in accordance with the result of the detection is provided so that the user can grasp that a proper operation has been performed, by vibration.

In the information terminal according to the present invention, the input portions are formed out of button switches or a touch panel. According to the aforementioned configuration, the input portions are made of button switches, so that the user can obtain a sense of clicking when the user operates a button. Thus, the user can surely perform an operation for executing a function intended by the user. Alternatively, the input portions are made of a touch panel, so that the degree of freedom on design can be increased.

### EFFECT OF THE INVENTION

According to the information terminal of the present invention, the control means for lighting a specified input portion is provided. Accordingly, the user can intuitively grasp that the user should operate the lit input portion. Thus, the user can easily perform an operation for executing a function intended by the user.

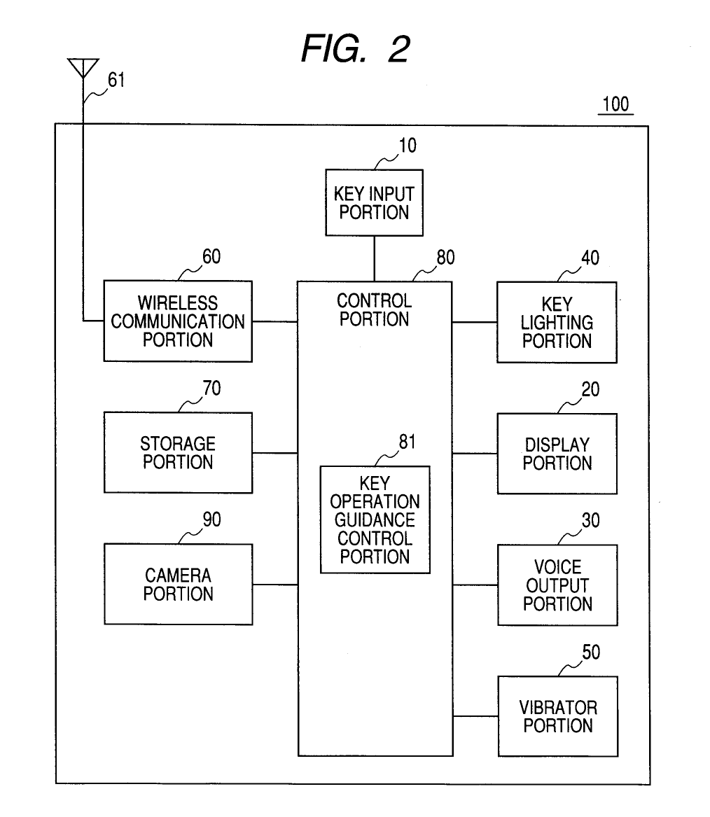

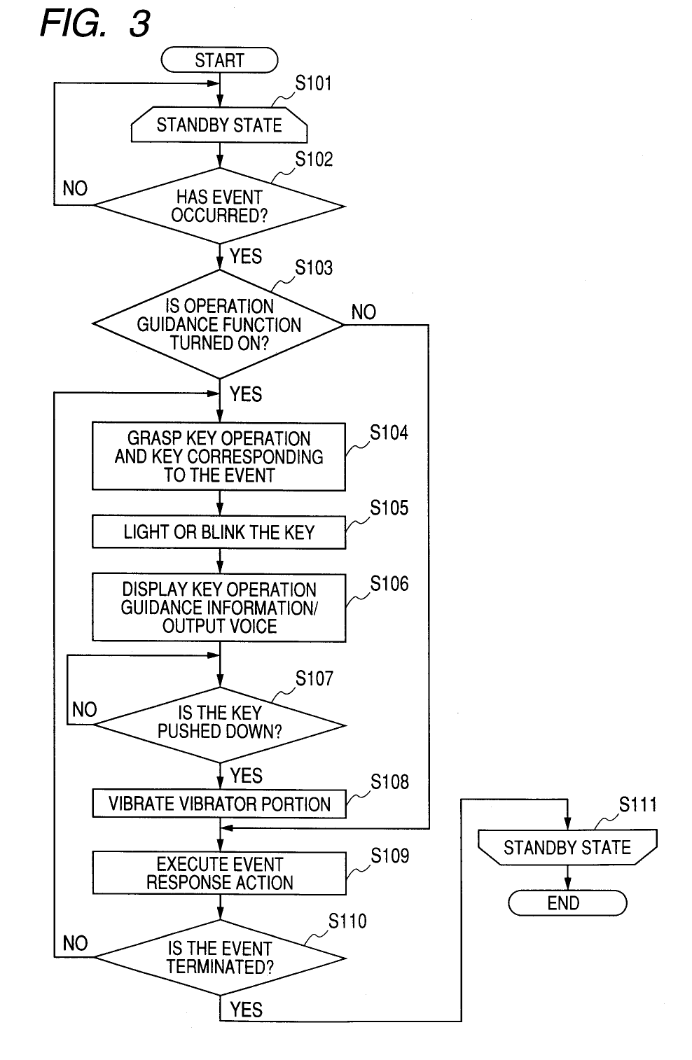

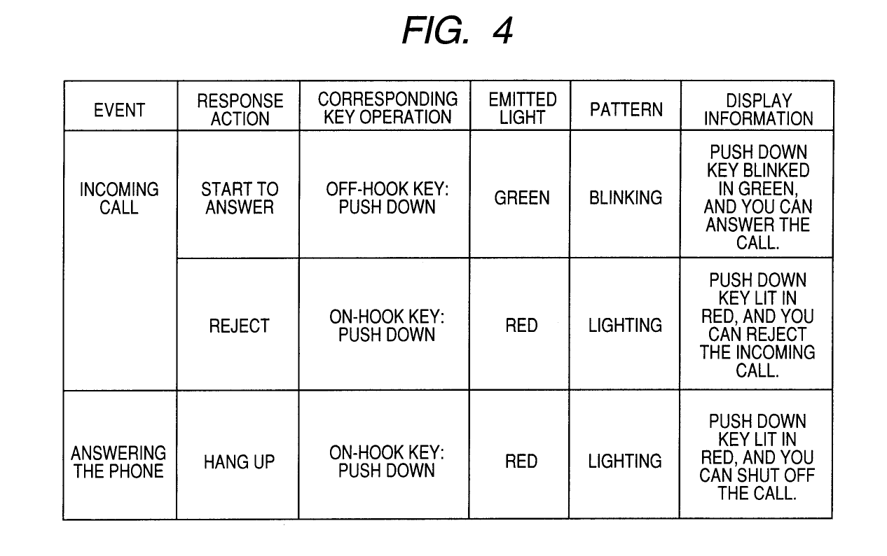

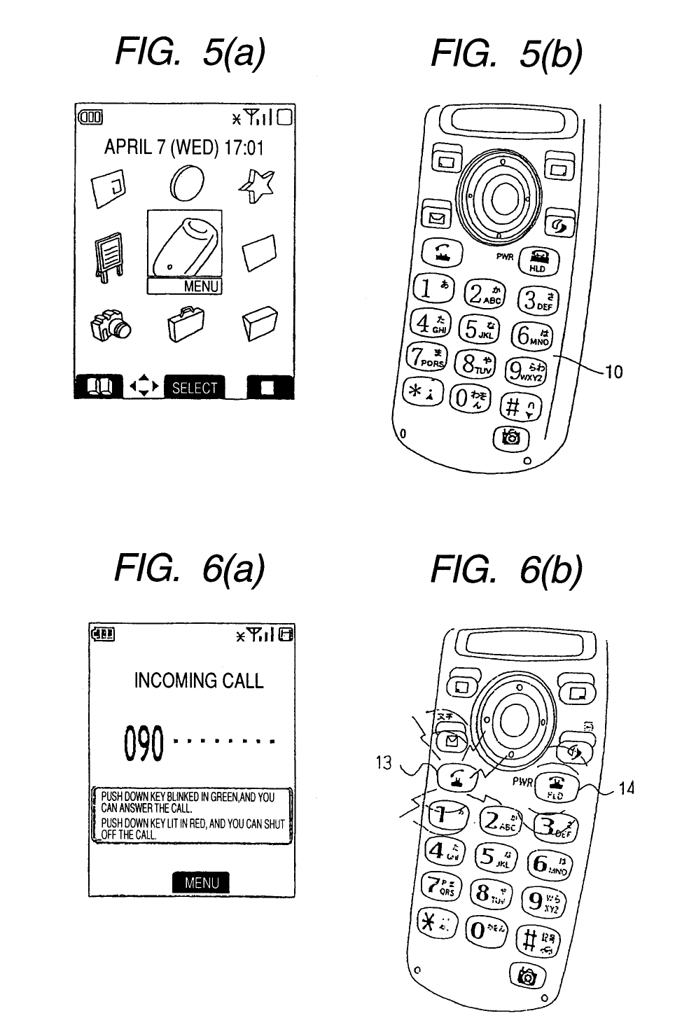

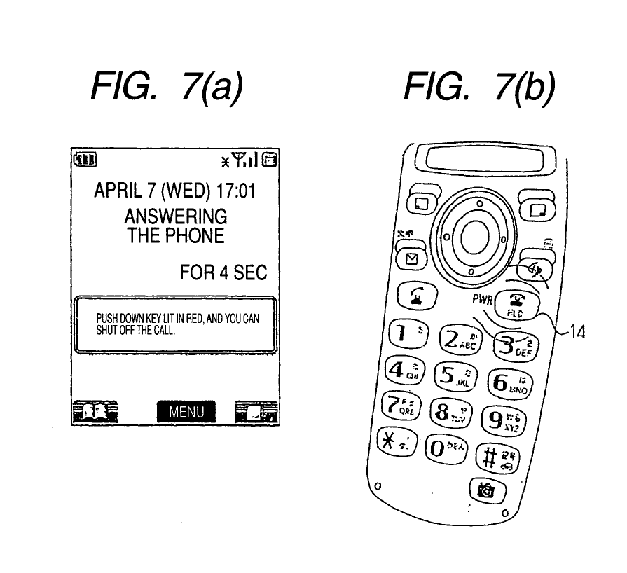

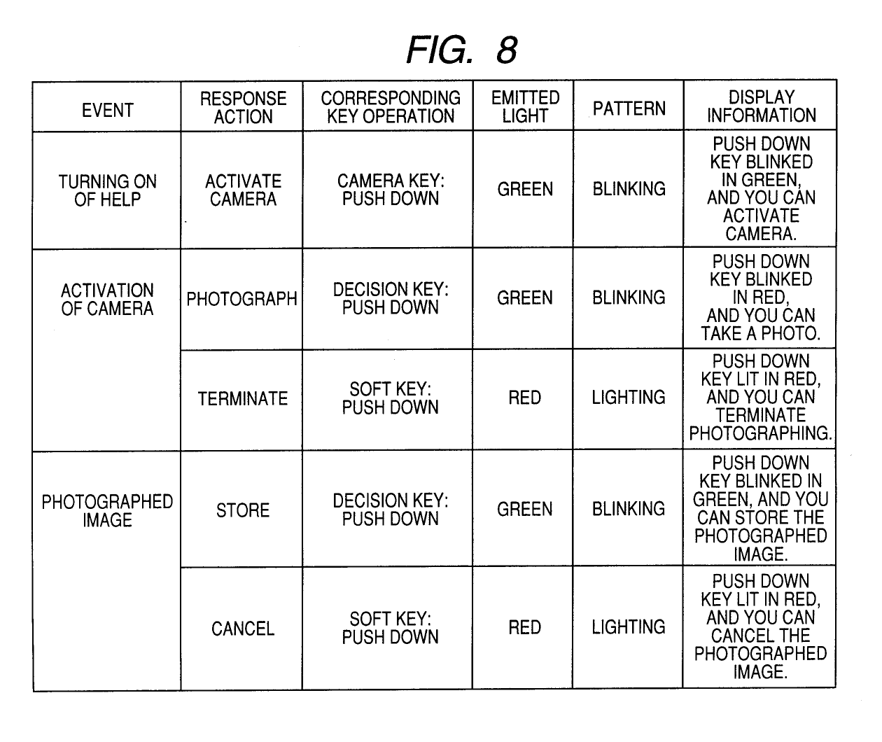

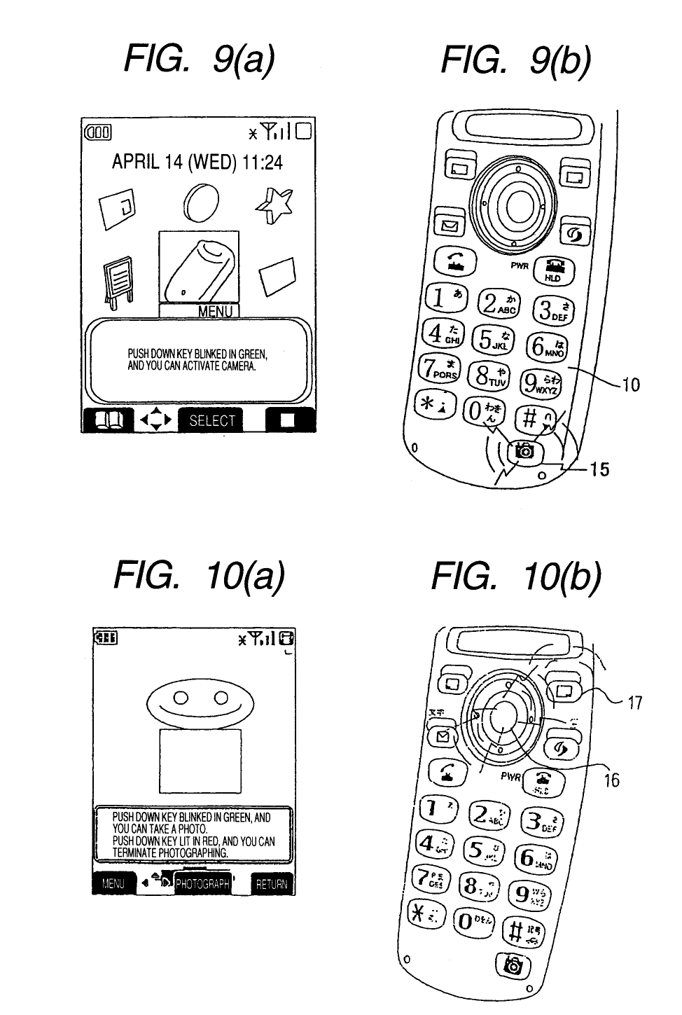

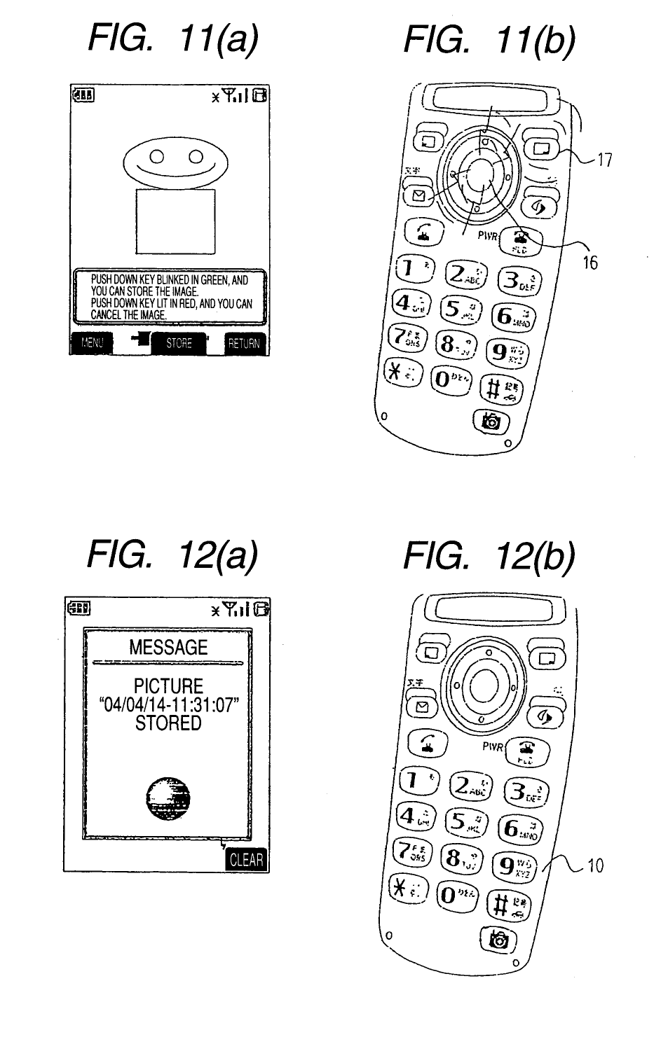

### BRIEF DESCRIPTION OF THE DRAWINGS

[FIG. 1] A view showing an external appearance of a mobile phone terminal for explaining an embodiment of the present invention.

[FIG. 2] A view showing an internal configuration of the mobile phone terminal according to the embodiment.

[FIG. 3] A flow chart showing a procedure of a key operation guidance control action of the mobile phone terminal according to the embodiment.

[FIG. 4] A table conceptually showing key operation guidance data including events and key operations corresponding to the events in the embodiment.

[FIG. 5] Views for schematically showing changes of states of a key input portion and a display portion of the mobile phone terminal at the time of occurrence of an incoming call (at the time of standby).

[FIG. 6] Views for schematically showing changes of states of the key input portion and the display portion of the mobile phone terminal at the time of occurrence of an incoming call (at the time of incoming calling).

[FIG. 7] Views for schematically showing changes of states of the key input portion and the display portion of the mobile phone terminal at the time of occurrence of an incoming call (at the time of answering).

[FIG. 8] A table conceptually showing key operation guidance data concerned with a camera function.

[FIG. 9] Views schematically showing changes of states of the key input portion and the display portion of the mobile phone terminal at the time of referring to a camera operation guide of a help menu (at the time of turning on guide reference).

[FIG. 10] Views schematically showing changes of states of the key input portion and the display portion of the mobile phone terminal at the time of referring to the camera operation guide of the help menu (at the time of activating a camera).

[FIG. 11] Views schematically showing changes of states of the key input portion and the display portion of the mobile phone terminal at the time of referring to the camera operation guide of the help menu (at the time of photographing an image).

[FIG. 12] Views schematically showing changes of states of the key input portion and the display portion of the mobile phone terminal at the time of referring to the camera operation guide of the help menu (at the time of storing the image).

### DESCRIPTION OF REFERENCE NUMERALS

10 key input portion
20 display portion
30 voice output portion
40 key lighting portion
50 vibrator portion
60 wireless communication portion
70 storage portion
80 control portion
81 key operation guidance control portion
90 camera portion
100 mobile phone terminal

### BEST MODE FOR CARRYING OUT THE INVENTION

An information terminal for explaining an embodiment of the present invention will be described below in detail with reference to the accompanying drawings. In the following embodiment, a mobile phone terminal will be described as an example of the information terminal. Incidentally, in all the drawings for explaining the embodiment, parts having the same functions are referenced correspondingly and redundant description thereof will be omitted.

FIG. 1 is a view showing an external appearance of the mobile phone terminal for explaining the embodiment of the present invention. As shown in FIG. 1, a mobile phone terminal 100 has a function for guiding a user to perform a key operation. This guiding function serves as an assistance function for assisting the user to perform an operation required for execution of a function set in the mobile phone terminal 100. The mobile phone terminal 100 is chiefly constituted by a key input portion 10, a display portion 20 and a voice output portion 30.

The key input portion 10 includes various keys (button switches) such as dial keys 11, a navigation button 12, etc. When the user pushes down one of the keys, input is executed. Key lighting portions 40 (not shown) constituted by LEDs etc. are provided respectively under the keys (in the inside of a body) of the key input portion 10 so as to be able to emit light independently in accordance with the respective keys or buttons. For example, addresses are given respectively to the key lighting portions for lighting the keys in advance. When one of the addresses is designated for light emission, the designated key lighting portion can be made to emit light independently. The display portion 20 is constituted by a liquid crystal display, an EL display, or the like. The display portion 20 displays information in accordance with light emission of the key lighting portions 40. The voice output portion 30 is constituted by a speaker etc. The voice output portion 30 vocalizes information in accordance with light emission of the key lighting portions 40. Incidentally, actions of the display portion 20, the voice output portion 30, etc. interlocking with the key lighting portions 40 will be described later.

FIG. 2 is a view showing an internal configuration of the mobile phone terminal according to the embodiment. The mobile phone terminal 100 includes a vibrator portion 50, a wireless communication portion 60, a storage portion 70, a control portion 80 and a camera portion 90 as well as the respective portions described in FIG. 1.

The vibrator portion 50 is constituted by a vibrator. The vibrator portion 50 vibrates in accordance with control of the control portion 80 which will be described later. The wireless communication portion 60 is a block for handling a function for forwarding/receiving a phone call or an electronic mail of the mobile phone terminal. The wireless communication portion 60 demodulates or decodes a radio wave received through an antenna 61 so as to generate received data, or modulates encoded transmission data into a predetermined frequency so as to transmit the transmission data from the antenna 61. The storage portion 70 stores various kinds of data such as programs to be performed by the control portion 80 for executing control, key operation guidance data which will be described later, image data, etc.

The control portion 80 is constituted by a CPU etc. so as to control actions of the respective portions of the mobile phone terminal in a lump. The control portion 80 includes a key operation guidance control portion 81. The key operation guidance control portion 81 has a function for specifying the key input portion 10 operated by the user for execution of a function set in the mobile phone terminal 100, and a function for lighting the specified key input portion 10. The key operation guidance control portion 81 grasps a key required for a key operation corresponding to an event, and performs key operation guidance control, for example, so as to make the key lighting portion 40 emit light correspondingly to the key or to make a display on the display portion 20. The key operation guidance control portion 81 has a function for detecting an operation on the specified key input portion 10, and a function for vibrating the vibrator portion 50 in accordance with a result of the detection. Incidentally, these control actions are implemented by the CPU executing the control programs.

The camera portion 90 is a known digital camera unit mounted on the mobile phone terminal. Photographed images are stored in the storage portion 70.

Next, a key operation guidance control action of the mobile phone terminal configured thus will be described.

FIG. 3 is a flow chart showing a procedure of the key operation guidance control action of the mobile phone terminal according to the embodiment. First, the mobile phone terminal 100 is in a standby state for the power to be turned on (Step S101). In the standby state, the control portion 80 monitors occurrence of an event (Step S102). The event mentioned here represents an internal event such as an incoming call, or an external event such as user's key pushing on the mobile phone terminal. Specific examples of such events will be described later. When the control portion 80 detects occurrence of an event, the control portion 80 determines whether a function of the key operation guidance control portion 81 is on or not (Step S103).

When the key operation guidance control function is on, the key operation guidance control portion 81 in the control portion 80 grasps the occurring event so as to specify a key the user should operate to execute a function corresponding to the event (grasp a key operation and a key) (Step S104). The relation etc. between a response action to the event and a key operation required for the response action is stored as data in the storage portion 70 in advance.

FIG. 4 is a table conceptually showing key operation guidance data including events and key operations corresponding to the events in the embodiment. In FIG. 4, the key operation guidance data including the relation between an event of an incoming call and keys required for key operations corresponding to the event are shown by way of example. For example, when an incoming call has occurred, the user of the mobile phone terminal can select a response action from “start to answer” or “reject (shut off the incoming call)”. Key operations corresponding to the response actions are to push down an “off-hook key” and to push down an “on-hook key” respectively. When the user pushes down one of the keys, the user can perform a key operation corresponding to the event. With reference to the key operation guidance control data stored in the storage portion 70, the key operation guidance control portion 81 grasps the key required for the corresponding key operation as described above. Incidentally, a function of a key in response to the case where an incoming call has occurred may be set as “hold” when the “on-hook key” is pushed down once, and as “reject” when the “on-hook key” is pushed down twice.

When the key operation guidance control portion 81 specifies the key required for the key operation corresponding to the event, the key operation guidance control portion 81 makes a key lighting portion 40 corresponding to the key light or blink the key (Step S105). At the same time, the key operation guidance control portion 81 makes key operation guidance information be displayed (or blinked) on the display portion 20, or makes key operation guidance information be informed by voice from the voice output portion 30 (Step S106). Thus, the user of the mobile phone terminal can intuitively grasp which key the user should push down as the key operation corresponding to the event.

The key operation guidance control portion 81 monitors whether the key blinked or lit by the key lighting portion 40 has been pushed down or not (Step S107). When the key operation guidance control portion 81 detects that the key has been pushed down, the key operation guidance control portion 81 vibrates the vibrator of the vibrator portion 50 (Step S108) and then executes an event response action assigned to the pushed key (Step S109). Thus, through the vibration, the user of the mobile phone terminal can intuitively grasp the fact that the key corresponding to the key has been pushed down.

Next, the control portion 80 determines whether an event has occurred due to the response action executed in Step S109 or not (Step 110). When another event has occurred, the control portion 80 makes the key operation guidance control portion 81 execute the procedure again from Step S104. On the other hand, when no event has occurred, the mobile phone terminal returns to the standby state (Step S111). The aforementioned procedure from Step 101 to Step S111 is executed repetitively in the standby state of the mobile phone terminal.

Next, specific examples of key operation guidance operations at the time of occurrence of events will be described. Here, description will be made about the case where a key operation guidance function is activated due to occurrence of each event. First, description will be made about a key operation guidance action at the time of an incoming call.

FIGS. 5 to 7 are views schematically showing changes of states of the key input portion 10 and the display portion 20 of the mobile phone terminal at the time of occurrence of an incoming call. In an initial standby state, a standby screen is displayed on the display portion 20 (FIG. 5(a)), but there is no key lit or blinked in the key input portion 10 (FIG. 5(b)).

When the wireless communication portion 60 detects an incoming call, the control portion 80 makes the display portion 20 display a message indicating reception of the incoming call together with a phone number. Further, the key operation guidance control portion 81 refers to data concerned with the incoming call from the key operation guidance data (see FIG. 4) stored in the storage portion 70. The key operation guidance control portion 81 blinks the key lighting portion of the off-hook key 13 in green and lights the key lighting portion of the on-hook key 14 in red (FIG. 6(b)). Since each key of the key input portion 10 is made of transparent or semi-transparent resin, the user can recognize light emitted from the key lighting portion 40 under the key and transmitted through the key. With reference to the key operation guidance data, the key operation guidance control portion 81 makes the display portion 20 display display information (assistance information) for assisting operations (FIG. 6(a)). Accordingly, the user can easily grasp that the call will start when the user pushes down the key blinked in green, and that the incoming call will be rejected when the user pushes down the key lit in red.

When a plurality of keys corresponding to a plurality of selectively executable actions respectively are lit in different modes as described above, identifiability in the case where there are a plurality of actions can be improved. Incidentally, colors of external characters (images indicating the respective keys) may be the same as the emitted colors when the display information is displayed. Accordingly, identifiability can be improved more greatly. Incidentally, lighting and blinking can be set desirably. For example, when a key is blinked, display can be also blinked synchronously. When a key is lit, display can be also lit synchronously. When a period for blinking the key is synchronized with a period for blinking and displaying assistance information, assistance for the user can be emphasized visually. In addition, as an example for visually emphasizing assistance for the user, a color of an external character and an emitted color of a key may be changed so that not only the blinking periods of the external character and the key but also periods of color changes may be synchronized with each other.

When the user of the mobile phone terminal pushes down the off-hook key 13, the control portion 80 makes the wireless communication portion 60 start the call (occurrence of an event). With reference to data concerned with answering the phone from the key operation guidance data (see FIG. 4) in the same manner as described above, the key operation guidance control portion 81 lights the key lighting portion of the on-hook key 14 in red (FIG. 7(b)). Further, with reference to the key operation guidance data, the key operation guidance control portion 81 makes the display portion 20 display display information (FIG. 7(a)). Accordingly, the user can easily grasp that the call will be terminated if the user pushes down the key lit in red.

When the user of the mobile phone terminal pushes down the on-hook key 14, the control portion 80 makes the wireless communication portion 60 terminate the call (termination of the event). Since sequential operations are guided correspondingly to occurrence of a series of events as described above, the user can easily complete an intended action only by pushing down a lit key.

Next, description will be made about a key operation guidance action in the case where the user of the mobile phone terminal has performed a key operation. Here, description will be made on the case where the user has performed a key operation to select an operation guide of a camera built in the mobile phone terminal. Incidentally, description about a specific key operation ranging from the standby screen to the camera operation guide in a help menu will be omitted because the key operation is known.

FIG. 8 is a table conceptually showing key operation guidance data concerned with a camera function. In FIG. 8, the key operation guidance data including the relation between events concerned with the camera operation guide of the help menu and keys required for key operations corresponding to the events are shown by way of example. The data are stored in the storage portion 70 in advance.

FIGS. 9 to 12 are views schematically showing changes of states of the key input portion 10 and the display portion 20 of the mobile phone terminal at the time of reference to the camera operation guide of the help menu. When the control portion 80 detects occurrence of an event that the user has selected the camera operation guide, the control portion 80 notifies the key operation guidance control portion 81 of the detection. With reference to data concerned with turning-on of a help of the camera operation guide from the key operation guidance data (see FIG. 8) stored in the storage portion 70, the key operation guidance control portion 81 blinks the key lighting portion of a camera key 15 in green (FIG. 9(b)). With reference to the key operation guidance data, the key operation guidance control portion 81 makes the display portion 20 display display information (FIG. 9(a)). Accordingly, the user can easily grasp that a camera will be activated if the user pushes down the key blinked in green.

When the user of the mobile phone terminal pushes down the camera key 15, the camera is activated (occurrence of an event) so that an image of a subject is displayed. With reference to data concerned with activation of the camera from the key operation guidance data (see FIG. 8) in the same manner as described above, the key operation guidance control portion 81 blinks the key lighting portion of a decision key 16 in green and lights the key lighting portion of a soft key 17 in red (FIG. 10(b)). Further, with reference to the key operation guidance data, the key operation guidance control portion 81 makes the display portion 20 display display information (FIG. 10(a)). Accordingly, the user can easily grasp that photographing will start if the user pushes down the key blinked in green, and that action of the camera will be terminated if the user pushes down the key lit in red. Incidentally, lighting and blinking can be set desirably. For example, when the key is blinked, display can be also blinked synchronously. When the key is lit, display can be also lit synchronously. When a period for blinking the key is synchronized with a period for blinking and displaying assistance information, assistance for the user can be emphasized visually.

When the user of the mobile phone terminal pushes down the decision key 16, the control portion 80 makes the camera portion start photographing (occurrence of an event). With reference to data concerned with the photographing from the key operation guidance data (see FIG. 8) in the same manner as described above, the key operation guidance control portion 81 blinks the key lighting portion of the decision key 16 in green and lights the key lighting portion of the soft key 17 in red (FIG. 11(b)). Further, with reference to the key operation guidance data, the key operation guidance control portion 81 makes the display portion 20 display display information (FIG. 11(a)). Accordingly, the user can easily grasp that a photographed image will be stored if the user pushes down the key blinked in green, and that the photographed image will be not stored but cancelled (abandoned) if the user pushes down the key lit in red. When a plurality of keys corresponding to a plurality of selectively executable actions respectively are lit in different modes in the aforementioned manner, identifiability in the case where there are a plurality of actions can be improved.

When the user of the mobile phone terminal pushes down the decision key 16, the photographed image is stored in the storage portion 70 and a confirmation message is displayed so that the camera operation guide is terminated (termination of the event). Since sequential operations are guided correspondingly to occurrence of a series of events as described above, the user can easily complete an intended action only by pushing down a lit key.

Although the key lighting portions are provided under the keys (inside the body) in the aforementioned embodiment, the key lighting portions do not have to be always provided under the keys. For example, the key lighting portions may be disposed in any way (e.g. near the right of the corresponding keys) as long as light emission of each of the key lighting portions can specify one key uniquely. The keys may be replaced by one or a plurality of touch panels etc. (including shapes of virtual keys displayed and a soft key assigned with a variable function) capable of emitting light partially. Further, at least one of the key input portion and the display portion may be formed as a touch panel.

Although description has been made on the case where the key lighting portions emit light in two kinds of colors, that is, green and red in the aforementioned embodiment, it is a matter of course that the key lighting portions can emit light in colors other than the aforementioned colors or in three or more kinds of colors. For example, a plurality of keys corresponding to three actions “answer”, “hang up” and “hold” which can be executed selectively at the time of an incoming call may be lit in different modes such as “answer: green”, “hang up: red” and “hold: yellow”. Incidentally, of user's response actions to an event, a key corresponding to the case of an action for continuing a function such as answering etc. may be lit in green while a key corresponding to the case of an action for aborting the function such as hanging up etc. is lit in red. In this manner, it is easy for the user to intuitively grasp the contents of each action from the color of light. Particularly, when the function is aborted, the corresponding key may be lit in a color such as red or yellow to draw the user's attention. In this manner, it is easy for the user to intuitively grasp that the user must perform the action carefully. Blinking the key can draw the user's attention more strongly. The period for blinking a key corresponding to an action for aborting a function may be changed (to be shorter than a normal period) so as to draw the user's attention.

The user may set images of external characters, emission colors of the keys and the external characters, the blinking period, and the color changing period. When the user performs the setting by himself/herself, the user can easily image the operation the user should perform.

When the user has performed a proper operation corresponding to an event (when the user has pushed down a lit or blinked key), a predetermined light source may be made to emit light in accordance with the blinking period, the color changing period, etc. of the key pushed down by the user. The light source made to emit light may be a light source located in a position where the user can recognize visually when the user operates the terminal. An example of this light source is an incoming call LED emitting light in response to an incoming call. With this configuration, the user can grasp that the proper operation has been performed, through the emitted light. Particularly when the lighting state of the key and the lighting state of the light source are made coincident with each other, it is easy for the user to intuitively grasp that the user has performed the proper operation.

Although description has been made on the mobile phone terminal as an example of the information terminal in the aforementioned embodiment, the present invention is not limited thereto. The present invention is applicable to any kind of information terminal having an input means such as a keyboard, a touch panel, etc., such as a PHS terminal, a PDA (Personal Digital Assistants), etc.

Although the present invention has been described in detail and with reference to its specific embodiment, it is obvious to those skilled in the art that various changes or modifications can be made without departing from the spirit and scope of the present invention.

This application is based on a Japanese patent application (Japanese Patent Application No. 2004-183763) filed on Jun. 22, 2004, the contents of which will be incorporated herein by reference.

### INDUSTRIAL APPLICABILITY

Since the information terminal according to the present invention has a control means for lighting a specified input portion, the user can intuitively grasp that the user should operate the lit input portion. Accordingly, there is an effect that the user can easily perform an operation for executing a function intended by the user. Accordingly, the present invention is useful to an information terminal etc. having an assistance function for assisting a user to perform an operation required for execution of a function set in the information terminal.

1: An information terminal having an assistance function for assisting a user to perform an operation required for execution of a function set in the information terminal, comprising:
an input unit including a plurality of input portions capable of emitting light independently of one another;
a specifying unit which specifies one of the input portions to be operated by the user for the purpose of executing the function; and
a lighting control unit which lights the specified input portion.

2: The information terminal according to claim 1,
wherein the assistance function is activated in response to occurrence of an event for executing the function set in the information terminal.

3: The information terminal according to claim 1,
wherein the specifying unit specifies a plurality of input portions corresponding to a plurality of selectively executable actions set for the function, and
wherein the lighting control unit lights the input portions in different modes respectively.

4: The information terminal according to claim 3,
wherein the lighting control unit lights the input portion corresponding to, of the plurality of selectively executable actions, an action for aborting the function, so as to draw user's attention.

5: The information terminal according to claim 3,
wherein the lighting control unit emphatically lights the input portion corresponding to, of the plurality of selectively executable actions, an action for advancing the function.

6: The information terminal according to claim 1, further comprising:
a display control unit which displays assistance information for assisting the operation at timing when the input portion is lit.

7: The information terminal according to claim 6,
wherein the specifying unit specifies a plurality of input portions corresponding to a plurality of selectively executable actions set for the function, and
wherein the display control unit displays a plurality of pieces of assistance information for assisting the operation in different modes.

8: The information terminal according to claim 1, further comprising:
a voice control unit which vocalizes the assistance information for assisting the operation at timing when the input portion is lit.

9: The information terminal according to claim 6, further comprising:
a control unit which synchronizes a period for the lighting control unit to blink the input portion with a period for the display control unit to blink and display the assistance information.

10: The information terminal according to claim 1, further comprising:
a detection unit which detects an operation on an input portion specified by the specifying unit; and
a vibrating unit which vibrates in accordance with a result of the detection.

11: The information terminal according to claim 1,
wherein the input portions are formed out of button switches or a touch panel.
